(19) United States
(12) Patent Application Publication
(10) Pub. No.: US 2026/0220370 A1
(43) Pub. Date: Jul. 30, 2026

(54) ANOMALY DETECTION APPARATUS, METHOD, AND STORAGE MEDIUM

(71) Applicant: KABUSHIKI KAISHA TOSHIBA, Kawasaki-shi (JP)

(72) Inventors: Naoki KAWAMURA, Yokohama Kanagawa (JP); Takahrio TAKIMOTO, Yokohama Kanagawa (JP); Osamu YAMAGUCHI, Yokohama Kanagawa (JP); Satoshi ITO, Kawasaki Kanagawa (JP); Gaku MINAMOTO, Kawasaki Kanagawa (JP); Tomohiro NAKAI, Kawasaki Kanagawa (JP)

(73) Assignee: KABUSHIKI KAISHA TOSHIBA, Kawasaki-shi (JP)

(21) Appl. No.: 19/454,038

(22) Filed: Jan. 20, 2026

(30) Foreign Application Priority Data
Jan. 30, 2025 (JP) 2025-014128

(51) Int. Cl. G06F 40/284; G06F 16/334

(52) U.S. Cl. CPC G06F 40/284; G06F 16/334

(57) ABSTRACT

According to one embodiment, an anomaly detection apparatus includes a metric training circuit and an update circuit. The metric training circuit generates one or more pre-update prompts for input to a multi-modal base model from a training sample and input text representing an aspect of the training sample by metric training based on a comparison between a sample and a prompt. The update circuit, for each of the generated pre-update prompts, generates a post-update prompt by searching for alternative text as an alternative to the input text included in the prompt, and replacing the input text with the alternative text.

### CROSS-REFERENCE TO RELATED APPLICATION

This application is based upon and claims the benefit of priority from Japanese Patent Application No. 2025-014128, filed Jan. 30, 2025, the entire contents of which are incorporated herein by reference.

### FIELD

Embodiments described herein relate generally to an anomaly detection apparatus, a method, and a storage medium.

### BACKGROUND

The multi-modal base model is a type of neural network, and can accurately solve a task using a plurality of input samples having different data formats. To obtain an appropriate output sample according to a user's purpose from an input sample by utilizing a multi-modal base model, design of a prompt describing the input sample is important. As an example, the prompt is designed manually. However, in order to obtain an appropriate output sample for an input sample, it is necessary to create several hundred to several thousand or more sentences in a text format. In addition, designing an appropriate prompt for obtaining an appropriate output sample requires specialized know-how on how to express words and phrases used for the prompt.

To reduce manual workload in prompt design, a method of semi-automating prompt generation by prompt learning has been proposed. However, even in the method based on the prompt learning, there is a case where the method of expressing the word or the phrase is unsolved.

For example, Non-Patent Literature 1 (K. Zhou, J. Yang, C. C. Loy, Z. Liu, Z. “Learning to prompt for vision-language models.” International Journal of Computer Vision, vol. 130, no. 9, pp. 2337-2348, Springer, 2022.) proposes a prompt learning method in an image classification task. A user inputs a class name of an image object in text, and estimates and/or interpolates tokens before and after a token corresponding to the text, thereby generating a prompt. However, the token corresponding to the text input by the user does not change before and after learning, and when the text is incomplete, the generated prompt may be inappropriate.

Non-Patent Literature 2 (X. Li, Z. Zhang, X. Tan, C. Chen, Y. Qu, Y. Xie, L. ma. “PromptAD: Learning prompts with only normal samples for few-shot anomaly detection.” CVPR2024.) proposes a prompt learning method in an image anomaly detection task. A user inputs an object name (or a class name of an object) of an image and a name of an anomaly that may occur in the object as prior knowledge in text, and estimates and/or interpolates a token appearing in a first half of a token corresponding to the text, thereby generating a prompt. However, even in this method, the token corresponding to the prior knowledge input by the user does not change before and after learning, and when the text input by the user as the prior knowledge is incomplete, the generated prompt may be inappropriate.

Patent Document 1 (US 2025/0104394 A1, “Scalable Prompt Learning for Large Vision-Language Models,” Robert Bosch GmbH, 2025) discloses a Text-to-Classifier system that combines a large language model with a neural prompt generator to transform natural-language descriptions of candidate classes into context prompt vectors, concatenate class name tokens to form soft prompts, and condition a CLIP-based VLM to output class prediction probabilities for sample images. However, the method assumes image classification task where a single object appears in an image; it presupposes a closed set of candidate classes provided as text tokens and does not address multi-label recognition scenarios, in which multiple descriptions may be associated with each class and multiple objects may appear within a single image.

### BRIEF DESCRIPTION OF DRAWINGS

FIG. 1 is a diagram illustrating a configuration example of an anomaly detection apparatus according to the present embodiment.

FIG. 2 is a diagram illustrating an example of a configuration of a prompt generation circuit illustrated in FIG. 1.

FIG. 3 is a diagram illustrating an example of a process of generating a prompt according to the present embodiment.

FIG. 4 is a diagram schematically illustrating transition of various pieces of data according to the first example.

FIG. 5 is a diagram schematically illustrating an example of a method of evaluating effectiveness of a post-update prompt.

FIG. 6 is a diagram illustrating an example of a comparison screen between a pre-update prompt and a post-update prompt.

FIG. 7 is a diagram schematically illustrating transition of various pieces of data according to the second example.

FIG. 8 is a diagram illustrating an example of a configuration of an anomaly detection circuit illustrated in FIG. 1.

FIG. 9 is a diagram illustrating a processing example of anomaly detection according to the present embodiment.

FIG. 10 is a diagram schematically illustrating input and output of a trained VLM.

### DETAILED DESCRIPTION

The anomaly detection apparatus according to the embodiment includes a metric training circuit and an update circuit. The metric training circuit generates one or more pre-update prompts for input to the multi-modal base model from the training sample and the input text representing the aspect of the training sample by metric training based on a comparison between the sample and the prompt. The update circuit searches for, for each of the generated pre-update prompts, alternative text as an alternative to the input text included in the prompt, and generates a post-update prompt by replacing the input text with the alternative text.

Hereinafter, an anomaly detection apparatus, a method, and a program according to the present embodiment will be described with reference to the drawings.

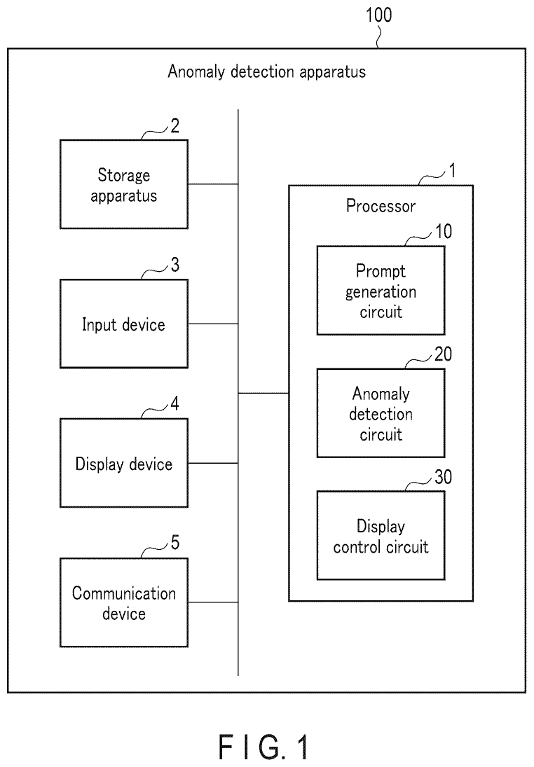

FIG. 1 is a diagram illustrating a configuration example of an anomaly detection apparatus 100 according to the present embodiment. As illustrated in FIG. 1, the anomaly detection apparatus 100 is a computer including a processor 1, a storage apparatus 2, an input device 3, a display device 4, and a communication device 5. Transmission and reception of data and various signals of the processor 1, the storage apparatus 2, the input device 3, the display device 4, and the communication device 5 are performed via a bus (Bus).

The processor 1 is an integrated circuit that controls the entire operation of the anomaly detection apparatus 100. For example, the processor 1 includes a central processing unit (CPU), a graphics processing unit (GPU), a digital signal processor (DSP), and/or a floating-point unit (FPU). The processor 1 may include an internal memory or an I/O interface. The processor 1 executes various processes by interpreting and calculating a program stored in advance by the storage apparatus 2 or the like. Part or the whole of the processor 1 may be realized by hardware such as an application specific integrated circuit (ASIC) or a field programmable gate array (FPGA).

The storage apparatus 2 is a volatile memory and/or a nonvolatile memory that stores various pieces of data. For example, the storage apparatus 2 stores data and setting values used in a case where the processor 1 executes various processes, data generated by various processes in the processor 1, and the like. The storage apparatus 2 includes a read only memory (ROM), a random access memory (RAM), a hard disk drive (HDD), a solid state drive (SSD), an integrated circuit storage apparatus, and the like. Note that the storage apparatus 2 may include a non-transitory computer-readable storage medium that stores a program executed by the processor 1.

The input device 3 receives inputs of various operations from an operator. As the input device 3, a keyboard, a mouse, various switches, a touch pad, a touch panel display, and the like can be used. The operation signal corresponding to the input of the received operation is supplied to the processor 1.

The display device 4 displays various pieces of data under the control of the processor 1. As the display device 4, a cathode-ray tube (CRT) display, a liquid crystal display, an organic electro luminescence (EL) display, a light-emitting diode (LED) display, a plasma display, or any other display can be appropriately used. The display device 4 may be a projector.

The communication device 5 includes a communication interface such as a network interface card (NIC) for performing data communication with various devices connected to the anomaly detection apparatus 100 via a network. Note that an operation signal may be supplied from a computer connected via the communication device 5 or an input device included in the computer, or various pieces of data may be displayed on a display device or the like included in the computer connected via the communication device 5. However, in order to simplify the following description, unless otherwise specified, it is assumed that the supply source of the operation signal is the input device 3 and the display destination of various pieces of data is the display device 4. The input device 3 can be replaced with a computer connected via the communication device 5 or an input device included in the computer, and the display device 4 can be replaced with a display device or the like included in the computer connected via the communication device 5.

The anomaly detection apparatus 100 does not need to include all of the processor 1, the storage apparatus 2, the input device 3, the display device 4, and the communication device 5. When necessary, some of the storage apparatus 2, the input device 3, the display device 4, and the communication device 5 may not be provided. The anomaly detection apparatus 100 may be provided with any additional hardware device useful for executing the processing according to the present embodiment. The anomaly detection apparatus 100 does not need to be physically configured by one computer, and may be configured by a computer system including a plurality of computers communicably connected via a wired or wireless network line or the like. The allocation of the series of processes according to the present embodiment to the plurality of processors 1 mounted on the plurality of computers can be set in any manner. All the processors 1 may execute all the processes in parallel, or a specific process may be assigned to one or some of the processors 1, and a series of processes according to the present embodiment may be executed as the entire computer system.

As illustrated in FIG. 1, the processor 1 includes, as an example, a prompt generation circuit 10, an anomaly detection circuit 20, and a display control circuit 30.

The prompt generation circuit 10 generates a prompt that is input to the multi-modal base model. The multi-modal base model is a neural network model that solves a preset task using data in a plurality of types of data formats (modalities). It is assumed that the task according to the present embodiment is an anomaly detection task that detects an anomaly included in an input sample using a prompt for describing an aspect of the input sample. In this case, the multi-modal base model receives the input sample and the prompt representing the aspect of the input sample to output the anomaly detection result. In the anomaly detection task, a plurality of different prompts is prepared for one input sample. The plurality of prompts is referred to as a prompt list. The data format of the sample is an image, a sound, a video, and/or coordinates. The data format of the prompt is text.

The anomaly detection circuit 20 applies the test sample and the prompt list generated by the prompt generation circuit 10 to the multi-modal base model, to output an anomaly detection result related to the test sample. The test sample means an input sample to be tested.

The display control circuit 30 displays various types of information on the display device 4. For example, the display control circuit 30 can display the anomaly detection result output by the anomaly detection circuit 20 on the display device 4. As another example, the display control circuit 30 can also display a prompt generated by the prompt generation circuit 10.

Hereinafter, a prompt generation process by the prompt generation circuit 10 and an anomaly detection process by the anomaly detection circuit 20 will be separately described.

### (Prompt Generation Process)

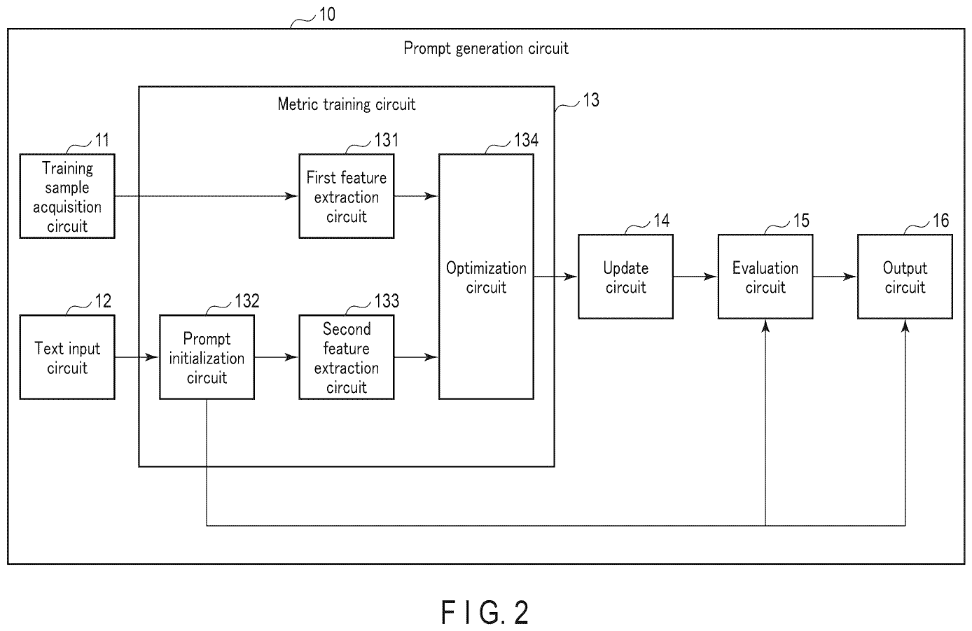

FIG. 2 is a diagram illustrating an example of a functional configuration of the prompt generation circuit 10 illustrated in FIG. 1. As illustrated in FIG. 2, the prompt generation circuit 10 includes a training sample acquisition circuit 11, a text input circuit 12, a metric training circuit 13, an update circuit 14, an evaluation circuit 15, and an output circuit 16.

The training sample acquisition circuit 11 acquires a training sample. The training sample is a normal sample including no anomaly. It is desirable that the training sample belongs to the same domain as the test sample. That is, it is desirable that the generation method, the category of the object included in the sample, the environment at the time of generation, and the like of the training sample match or are similar to those of the test sample. Note that the training sample may belong to a domain different from the domain of the test sample as long as a prompt can be shared between the training sample and the test sample.

The text input circuit 12 receives the input text representing the aspect of the training sample acquired by the training sample acquisition circuit 11. Specifically, the “input text” according to the present embodiment includes first text representing an aspect that may appear in the training sample and whose detection by the multi-modal base model is not desired, second text representing an object of the test sample input to the multi-modal base model, and/or third text representing an aspect whose detection by the multi-modal base model is desired. The input text is used as prior knowledge. The input text is input by the user via the input device 3, for example.

The metric training circuit 13 generates one or more pre-update prompts (hereinafter, referred to as a pre-update prompt) for input to the multi-modal base model from the training sample acquired by the training sample acquisition circuit 11 and the input text representing the aspect of the training sample, the input text being input by the text input circuit 12, by metric training based on a comparison between the sample and the prompt. The “prompt” according to the present embodiment means a character string in a text format including one or more tokens. The “token” according to the present embodiment means a character string including one or more words or one or more characters or an identification value corresponding to the character string. The token described as the identification value is converted by inputting the token described as a character string into a tokenizer.

As illustrated in FIG. 2, the metric training circuit 13 specifically includes a first feature extraction circuit 131, a prompt initialization circuit 132, a second feature extraction circuit 133, and an optimization circuit 134.

The first feature extraction circuit 131 extracts a first feature from the training sample acquired by the training sample acquisition circuit 11. The first feature means a feature in which the feature of the training sample is described as a scalar or a vector. The prompt initialization circuit 132 generates one or more initial prompts (hereinafter, referred to as an initial prompt) from the input text input by the text input circuit 12. The generation of the initial prompt is referred to as prompt initialization. The second feature extraction circuit 133 extracts the second feature from each of the initial prompts generated by the prompt initialization circuit 132. Specifically, the second feature extraction circuit 133 converts the initial prompt in a text format into an initial prompt in a feature vector format by inputting the initial prompt in a text format into a text encoder. The initial prompt in the feature vector format is an example of the second feature. At this time, the second feature extraction circuit 133 converts each token in the format of a character string or an identification value constituting the initial prompt into each token in the feature vector format by inputting the token to the text encoder. The second feature means a feature in which the feature of the input text is described as a scalar or a vector. The optimization circuit 134 generates a pre-update prompt in which the degree of similarity between the first feature extracted by the first feature extraction circuit 131 and the second feature extracted by the second feature extraction circuit 133 satisfies a predetermined criterion. The predetermined criterion means a criterion for optimization of the prompt. Hereinafter, the predetermined criterion is referred to as an optimization criterion.

For each of the pre-update prompts generated by the metric training circuit 13, the update circuit 14 searches for alternative text as an alternative to the input text included in the prompt, and replaces the input text with the alternative text, thereby generating a post-update prompt (hereinafter, referred to as an updated prompt). At this time, the update circuit 14 may replace the token corresponding to the input text or the feature vector corresponding to the token with the token corresponding to the alternative text or the feature vector corresponding to the token. As the alternative text, for example, the text similar to the input text is used.

The evaluation circuit 15 evaluates the effectiveness of the post-update prompt as an input to the multi-modal base model based on the detection result of the anomaly by the post-update prompt generated by the update circuit 14 or a comparison between the detection result of the anomaly by the post-update prompt and the detection result of the anomaly by the pre-update prompt.

In a case where there is a post-update prompt that is evaluated by the evaluation circuit 15 to be effective as an input to the multi-modal base model, the output circuit 16 adds the post-update prompt to a list of prompts (hereinafter, referred to as a prompt list) to use for the input to the multi-modal base model. On the other hand, in a case where there is no post-update prompt evaluated by the evaluation circuit 15 to be effective as an input to the multi-modal base model, the output circuit 16 discards the post-update prompt and adds the pre-update prompt to the prompt list.

Next, the prompt generation process of the anomaly detection apparatus 100 will be specifically described separately for the first example and the second example. In the following description, it is assumed that the data format of the sample is an image. In addition, it is assumed that the character string of the input text and the prompt is English, but the character string according to the present embodiment can be any language such as Japanese, Chinese, German, French, Korean, and Arabic.

When a new input image (test image) is given, the anomaly detection apparatus 100 determines whether an anomaly part is included in the test image using a trained visual language base model (Large Vision Language Model: VLM), and visualizes the anomaly part to the user. At this time, the user inputs input text indicating prior knowledge of the image in advance. The trained VLM is an example of a multi-modal base model.

### First Example

The prior knowledge according to the first example is assumed to be a first text indicating an aspect that may appear in the test image and whose detection is not desired. Hereinafter, the “aspect” in the test image may be referred to as a “structure”. For example, in a case where an anomaly on a road surface is detected in a test image captured by an in-vehicle camera while a vehicle is traveling on a road, the text is character strings in English such as “sky”, “walker”, and “building”. The structure referred to by the text mentioned in the example is generally a normal structure, but may be overdetected in the anomaly detection task of the in-vehicle camera image. Therefore, it is assumed that prior knowledge about the structure that is not desired to be detected is given by text from the user. It is an object to generate a prompt based on this text, thereby generating a prompt available for suppressing overdetection at the time of anomaly detection.

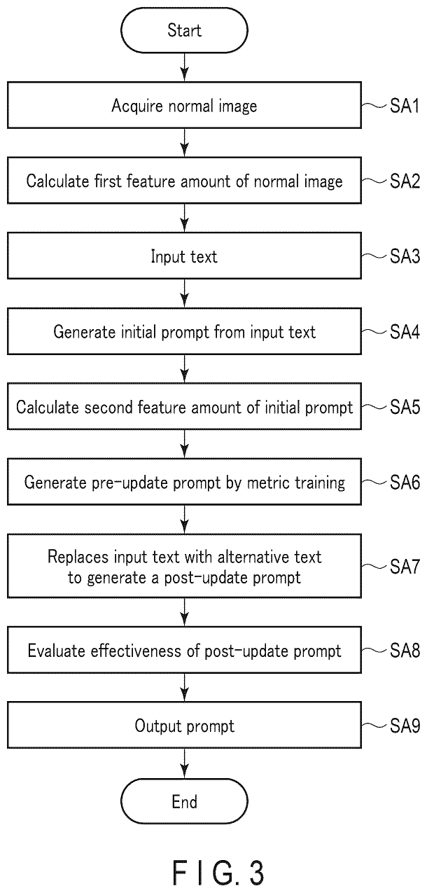

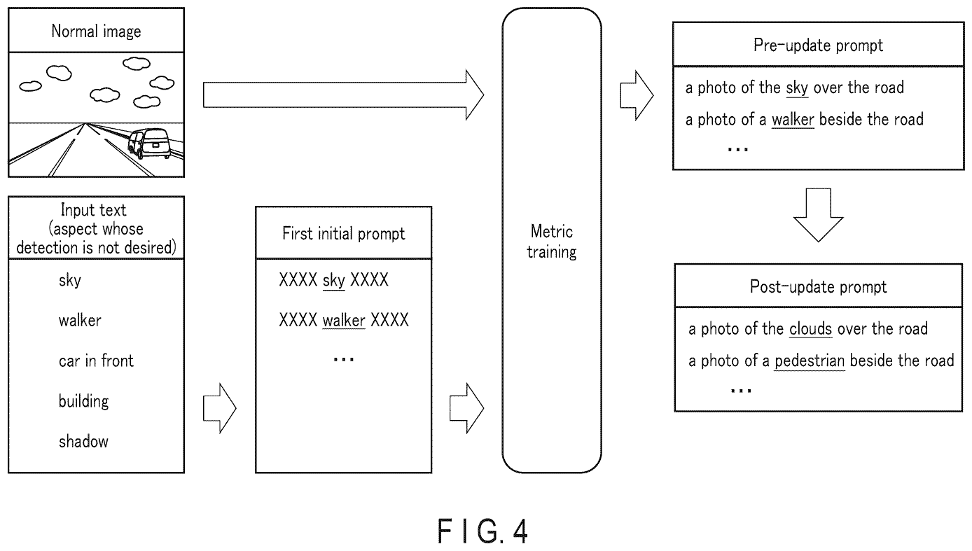

FIG. 3 is a diagram illustrating an example of a process of generating a prompt according to the first example. FIG. 4 is a diagram schematically illustrating a transition of various pieces of data according to the first example.

As illustrated in FIGS. 3 and 4, the training sample acquisition circuit 11 acquires a normal image (step SA1). The normal image is an example of a training sample, and is an image for training that does not include an anomaly. Specifically, the training sample acquisition circuit 11 acquires a data set including one or more normal images. It is desirable that the normal image and the test image belong to the same image domain. In this case, it is assumed that the normal image and the test image match or are similar to each other in a photographing method, a category of a photographing target, an environment at the time of photographing, and the like. For example, as illustrated in FIG. 4, an image showing a road is acquired as a normal image.

In a case where step SA1 is performed, the first feature extraction circuit 131 calculates a feature (first feature) of the normal image acquired in step SA1 (step SA2). Specifically, the first feature extraction circuit 131 applies each normal image included in the normal image data set to a trained vision transformer (ViT) to extract an image feature from each normal image. The image feature is an example of the first feature. The image feature may be obtained from the entire image of the normal image, or may be obtained for each pixel or patch. As an example, the first feature extraction circuit 131 extracts a feature vector output from the output layer of the trained ViT or a feature map output from each intermediate layer as the first feature. As another example, the first feature extraction circuit 131 may combine the feature vector and the feature map to calculate the combined feature vector and feature map as the first feature.

In a case where step SA2 is performed, the text input circuit 12 inputs a first text indicating an aspect that may appear in the test image and whose detection is not desired (step SA3). As illustrated in FIG. 4, “sky”, “walker”, “car in front”, “building”, and “shadow” are input as the first text. The first text is input by the user via the input device 3, for example.

In a case where step SA3 is performed, the prompt initialization circuit 132 generates an initial prompt from the input text (first text) input in step SA3 (step SA4). The prompt initialization circuit 132 generates an initial prompt from the first text according to a predetermined rule. Specifically, the prompt initialization circuit 132 generates the first initial prompt by converting the first text into the first center token, disposing a predetermined number of first preceding tokens with any values in front of the first center token, and/or disposing a predetermined number of first subsequent tokens with any values behind the first center token.

For example, as shown in FIG. 4, for the first center token “sky”, the first preceding token “XXXX” and the first subsequent token “XXXX” are disposed, and the first initial prompt “XXXX sky XXXX” is generated. Similarly, for the first center token “walker”, the first preceding token “XXXX” and the first subsequent token “XXXX” are disposed and the first initial prompt “XXXX walker XXXX” is generated. Each “XXXX” represents four any values. Different any values or the same any value may be disposed in each “XXXX”. In addition, as described above, the first subsequent token is not essential and may not be disposed. Note that, in FIG. 4, for convenience of description, a character string such as “sky” is illustrated as a specific example of the token, but the token may be an identification value.

Hereinafter, an example of the initial prompt generation process will be described in detail. First, the prompt initialization circuit 132 inputs the first text to a tokenizer to obtain one or more tokens T_{obj}. The token T_{obj} corresponds to the first center token. Next, the prompt initialization circuit 132 interpolates tokens before and after the token Toby using the token with any value. As a result, the first initial prompt is configured. Here, the prompt initialization circuit 132 arranges N tokens with any values before the token Tobi and arranges M tokens with any values after the token T_{obj}. N tokens disposed in front of the token T_{obj} correspond to the first preceding token, and M tokens disposed behind the token T_{obj} correspond to the first subsequent token. However, N is an integer of 1 or more, M is an integer of 0 or more, and when M=0, the first subsequent token is not disposed. For one input text, L (L is an integer greater than or equal to 1) first initial prompts are created. The prompt initialization circuit 132 performs this procedure on all text.

The L first initial prompts corresponding to the center token Tobin corresponding to the n-th first text may be expressed, for example, by the following Expression (1): In Expression (1), pₙ is the n-th first initial prompt, and T_{n,m} is a token with any value. The token T_{n,m} disposed in front of the center token T_{obj1} is the preceding token, and the token T_{n,m} disposed behind the center token T_{obj1} is the subsequent token. The token T_{n, m} may be, for example, a token having a value obtained by a random number generator, or may be a token obtained by inputting any character string into a tokenizer.

$${p}_{1} = [ {T}_{1 , 1} ] [ {T}_{1 , 2} ] ⋯ [ {T}_{1 , N} ] [ {T}_{{obj}_{1}} ] [ {T}_{1 , N + 1} ] [ {T}_{1 , N + 2} ] ⋯ [ {T}_{1 , N + M} ] , \qquad ( 1 )$$

$${p}_{2} = [ {T}_{2 , 1} ] [ {T}_{2 , 2} ] ⋯ [ {T}_{2 , N} ] [ {T}_{{obj}_{1}} ] [ {T}_{2 , N + 1} ] [ {T}_{2 , N + 2} ] ⋯ [ {T}_{2 , N + M} ] ,$$

$$⋮$$

$${p}_{L} = [ {T}_{L , 1} ] [ {T}_{L , 2} ] ⋯ [ {T}_{L , N} ] [ {T}_{{obj}_{1}} ] [ {T}_{L , N + 1} ] [ {T}_{L , N + 2} ] ⋯ [ {T}_{L , N + M} ] .$$

In a case where step SA4 is performed, the second feature extraction circuit 133 calculates the second feature of the initial prompt generated in step SA4 (step SA5). Specifically, the second feature extraction circuit 133 inputs each of the L first initial prompts to the trained text encoder, and executes forward propagation calculation according to the network structure of the trained text encoder, thereby converting each of the L first initial prompts to a feature vector. The feature vector is an example of the second feature. Here, a feature vector obtained by performing feature transformation on the prompt pᵢ in Expression (1) by the text encoder is expressed as wᵢ=g (pᵢ). wᵢ is a prompt in a feature vector format corresponding to the prompt pᵢ in a character string format.

In a case where step SA5 is performed, the optimization circuit 134 generates a pre-update prompt by metric training (step SA6). Specifically, the optimization circuit 134 trains the second feature regarding the initial prompt, that is, the prompt in the feature vector format, so that the degree of similarity between the first feature based on the normal image and the second feature based on the input text increases, and generates, as the pre-update prompt, the prompt when the degree of similarity satisfies the optimization criterion. The optimization criterion can be set in any criterion. As an example, in a case where the degree of similarity is designed to be larger as the value is larger, the optimization criterion is set so that the degree of similarity takes the maximum value.

The mathematical expression of the metric training according to the first example can be expressed by the following Expression (2). That is, the optimization circuit 134 searches for the feature vector wᵢ that minimizes the loss value E_{z} based on the feature vector wᵢ and the normal image feature z as a local solution. The loss value E_{z} is a value of a loss function that evaluates the degree of similarity exp<wᵢ, z/τ> between the feature vector wᵢ and the normal image feature z. The loss function of Expression (2) is defined by the cross entropy as an example, and exp<wᵢ, z/τ> is designed so that the smaller the loss value E_{z}, the larger the degree of similarity. Note that W is a set of L prompts wᵢ in the feature vector form, and t is a hyperparameter.

$$arg {min}_{{w}_{i}} \{ {𝔼}_{z} [ - log \frac{exp ( < {w}_{i} , z / τ > )}{{\sum }_{{w}_{j} ∈ W} exp ( < {w}_{j} , z / τ > )} ] \} \qquad ( 2 )$$

As an example, the optimization circuit 134 calculates the feature vector wᵢ of the initial prompt, calculates the loss value E_{z}, and updates the feature vector wᵢ with a predetermined step width so that the loss value E_{z} decreases. The optimization circuit 134 calculates the loss value E_{z} again for the updated feature vector wᵢ, and updates the feature vector wᵢ with a predetermined step width so that the loss value E_{z} is small. In this manner, the optimization circuit 134 repeats the calculation process of the loss value E_{z} and the update process of the feature vector wᵢ by a predetermined number of iterations. Then, the optimization circuit 134 regards and outputs the feature vector wᵢ after a predetermined number of iterations as a local solution giving the smallest loss value E_{z}, and outputs a prompt corresponding to the feature vector wᵢ as a pre-update prompt. The pre-update prompt pᵢ is generated for each of the L initial prompts.

For example, as illustrated in FIG. 4, the first preceding token “a photo of the” and the first subsequent token “over the road” are calculated by the metric training in step SA6 for the pre-update prompt related to the first center token “sky”, and the first preceding token “a photo of the” and the first subsequent token “beside the road” are calculated for the pre-update prompt related to the first center token “walker”.

In a case where step SA6 is performed, the update circuit 14 replaces the input text with the alternative text and generates a post-update prompt (step SA7). Specifically, the update circuit 14 identifies the token corresponding to the input text included in the update prompt generated in step SA6. The position of the token corresponding to the input text can be calculated from a preset value of N (the number of preceding tokens) and the output length of the text encoder. For example, in a case where a text encoder that outputs a 512 dimensional feature vector for one character string token is used, the position of the token corresponding to the input text is 512N+1 to 512 (N+1)-th dimension in the prompt in the feature vector format. The update circuit 14 then generates a post-update prompt by replacing the identified token with a token corresponding to the alternative text that is similar to the input text. The post-update prompt is generated for each of the L pre-update prompts.

A method of obtaining the alternative text is not particularly limited, and for example, the following two methods are conceivable.

First method: the update circuit 14 inquires of a large language model (LLM) about text as an alternative to the input text, and obtains text output from the large language model as the alternative text. Specifically, the update circuit 14 inquires of the large language model about a paraphrase representation of the input text or an object name associated from the input text as an alternative text. The update circuit 14 applies the text output from the large language model by the inquiry to a tokenizer to convert the text into a token, and applies the token to a text encoder to convert the token into a feature vector (similar feature vector). Then, the update circuit 14 replaces the feature vector (input feature vector) disposed at the corresponding position in the pre-update prompt with the similar feature vector. As a result, a post-update prompt is generated.

Second method: the update circuit 14 obtains, as the alternative text, text corresponding to a token similar to the token of the input text in the feature space. Specifically, the update circuit 14 applies the token of the input text to the trained text encoder to convert the token into a feature vector (input feature vector). Next, the update circuit 14 samples a feature vector (similar feature vector) within a predetermined distance from the input feature vector in the feature space. The predetermined distance may be set to any distance that is considered to be similar to the input feature vector. Although there are various sampling methods, for example, the update circuit 14 may perturb the input feature vector within a predetermined distance and calculate a point to be perturbed as a similar feature vector, or may calculate a neighborhood point of the input feature vector as a similar feature vector according to a normal distribution. Then, the update circuit 14 replaces the input feature vector disposed at the corresponding position in the pre-update prompt with the similar feature vector. As a result, a post-update prompt is generated.

For example, as shown in FIG. 4, for the pre-update prompt “a photo of the sky over the road” about the first center token “sky”, “sky” is replaced with the alternative text “clouds” to generate the post-update prompt “a photo of the clouds over the road”. Also, for the pre-update prompt “a photo of a walker beside the road” for the first center token “walker”, the “walker” is replaced with the alternative text “pedestrian” to generate the post-update prompt “a photo of a pedestrian beside the road”.

In a case where step SA7 is performed, the evaluation circuit 15 evaluates the effectiveness of the post-update prompt generated in step SA7 (step SA8). As an example, the evaluation circuit 15 evaluates the effectiveness of the post-update prompt based on a comparison between the detection result of the anomaly by the post-update prompt and the detection result of the anomaly by the pre-update prompt. Effectiveness is evaluated for each of the L post-update prompts.

The “effectiveness” according to the present embodiment means the degree to which the post-update prompt meets the intention of anomaly detection. Specifically, it means the degree to which the VLM can recognize the structure that may appear in the test image and whose detection the user does not desire, as intended by the user. Since it is difficult to directly evaluate this measure of effectiveness, the evaluation circuit 15 performs evaluation by the following method.

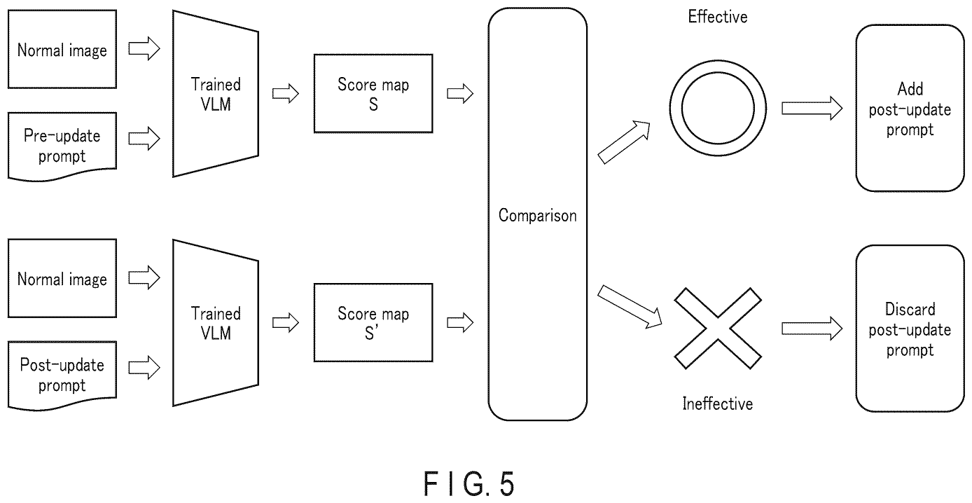

FIG. 5 is a diagram schematically illustrating an example of a method of evaluating effectiveness of a post-update prompt. As illustrated in FIG. 5, the evaluation circuit 15 evaluates the effectiveness of the post-update prompt based on a comparison between a score map S representing the detection result of the anomaly by the post-update prompt and a score map S′ representing the detection result of the anomaly by the pre-update prompt. Each process will be described below.

First, the evaluation circuit 15 generates the score map S by applying the post-update prompt and the normal image to the trained VLM, and generates the score map S′ by applying the pre-update prompt and the normal image to the trained VLM. Both normal images are the same. The score map represents a spatial distribution of the reaction degree in units of pixels when an image is input to any neural network model. When an image is input to the neural network model, the score map is output from any intermediate layer of the neural network model. It can be interpreted that the higher the value in the score map, the more the neural network model focuses on the corresponding pixel in the image. In addition, a visual score map and/or a language score map described later may be used as the score map.

Next, the evaluation circuit 15 calculates a comparison index value of the score map S with respect to the score map S′, and evaluates the effectiveness based on the comparison index value. As the comparison index, an increase or decrease in a statistical value of a pixel value (reaction degree) of the entire score map, or an increase or decrease in a statistical value of a region (hereinafter, referred to as a high reaction region) having a pixel value equal to or larger than a threshold value in the score map may be used. As the statistical value, for example, an average value, a median value, or a maximum value can be used. In a case where the subtraction value of the statistical value of the score map S from the statistical value of the score map S′ is greater than the threshold value, the evaluation circuit 15 determines that the post-update prompt, in other words, the alternative text, is effective. On the other hand, in a case where the subtraction value of the statistical value of the score map S from the statistical value of the score map S′ is smaller than the threshold value, the evaluation circuit 15 determines that the post-update prompt, in other words, the alternative text is ineffective.

As the comparison index, a change in the histogram of the entire score map, a change in the histogram in the high reaction region, a change in the position of the high reaction region, and a change in the size of the high reaction region may be used. In a case where the change in the score map S with respect to the score map S′ is greater than the threshold value or has consistency with a certain value or more, the evaluation circuit 15 determines that the post-update prompt, in other words, the alternative text, is effective. On the other hand, in a case where the change in the score map S with respect to the score map S′ is smaller than the threshold value or has no consistency with a certain value or more, the evaluation circuit 15 determines that the post-update prompt, in other words, the alternative text is ineffective.

The evaluation circuit 15 may evaluate the effectiveness of the post-update prompt based on the score map indicating the detection result of the anomaly by the post-update prompt without using the score map indicating the detection result of the anomaly by the pre-update prompt. As an example of the evaluation method, the evaluation circuit 15 inquires of a visual question answering (VQA) model about a high reaction region of the score map to evaluate consistency. Specifically, first, the evaluation circuit 15 colors the high reaction region in red, and generates a superimposed image in which the red high reaction region is superimposed on the normal image. The evaluation circuit 15 inputs the superimposed image and a question sentence indicating content of an inquiry about what the red portion is to the VQA. In response to the input, the VOA outputs text about the object appearing in the high reaction region. The evaluation circuit 15 determines that the post-update prompt, in other words, the alternative text is effective when the text output by VOA and the alternative text match or have consistency with a certain value or more.

In the above evaluation method, a score map representing an anomaly detection result by a prompt is used. However, the evaluation method according to the present embodiment is not limited thereto. As another example, the evaluation circuit 15 may evaluate the effectiveness based on the degree of similarity in the feature space between the post-update prompt and the pre-update prompt. Specifically, first, the evaluation circuit 15 calculates the feature vector by applying the post-update prompt to the trained VLM, and calculates the feature vector by applying the pre-update prompt to the VLM. Then, the evaluation circuit 15 calculates the distance between both the calculated feature vectors in the feature space, and in a case where the calculated distance is smaller than the threshold value, the evaluation circuit evaluates that the post-update prompt is effective, and in a case where the calculated distance is larger than the threshold value, the evaluation circuit evaluates that the post-update prompt is not effective.

As another evaluation method of the effectiveness, two or more evaluation results of the above evaluation methods may be added and evaluated. For example, the evaluation circuit 15 evaluates the post-update prompt as effective in a case where the post-update prompt is evaluated to be effective in both the first evaluation method and the second evaluation method, and evaluates the post-update prompt as not effective in a case where the post-update prompt is evaluated not to be effective in one of the first evaluation method and the second evaluation method.

In a case where step SA7 is performed, the output circuit 16 outputs a prompt (step SA8). Specifically, in a case where there is a post-update prompt evaluated to be effective in step SA8, the output circuit 16 adds the post-update prompt to the prompt list. At this time, the output circuit 16 may add the pre-update prompt to the prompt list in addition to the post-update prompt. On the other hand, in a case where there is no post-update prompt evaluated to be effective in step SA8, the output circuit 16 discards the post-update prompt and adds the pre-update prompt to the prompt list. After completion of the addition and/or discard of the L post-update prompts, the output circuit 16 outputs the prompt list.

An output format of the prompt list can be selected in any format. For example, the output circuit 16 adds any extension to the prompt list and stores the prompt list in the storage apparatus 2. In a case where the prompt is a sentence, the output circuit 16 stores the prompt list in a text format in the storage apparatus 2, and in a case where the prompt is not in a text format, that is, in a case where the prompt is in a feature vector format, stores the prompt list in a binary format in the storage apparatus 2.

As described above, the prompt generation process according to the first example ends.

Note that the processing example illustrated in FIG. 3 is an example, and the present embodiment is not limited thereto, and various types of processing can be added, deleted, and/or changed without departing from the gist of the invention.

As an example, the order of the normal image acquisition process (SA1)—the first feature calculation process (SA2), and the text input process (SA3)—the second feature calculation process (SA5) can be changed. In a case where there is no need to evaluate the effectiveness of the post-update prompt, the evaluation process (SA8) can be omitted. In this case, the entire post-update prompt may be added to the prompt list, or the entire pre-update prompt and the entire post-update prompt may be added to the prompt list.

As another example, after the evaluation process (SA8) of the effectiveness, the display control circuit 30 may display the pre-update prompt and the post-update prompt side by side on the display device 4 in order to compare the pre-update prompt and the post-update prompt. Further, the display control circuit 30 may display the score map based on the pre-update prompt and the normal image and the score map based on the post-update prompt and the normal image side by side. The layout of the comparison screen between the pre-update prompt and the post-update prompt can be designed in any layout.

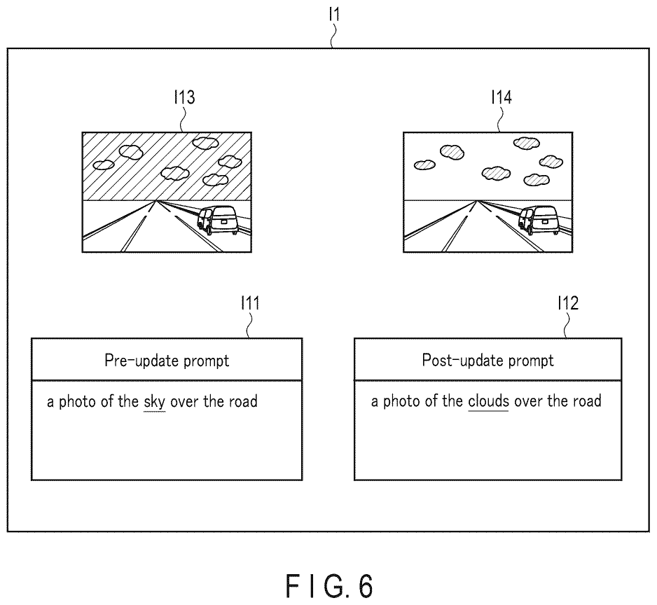

FIG. 6 is a diagram illustrating an example of a comparison screen I1 of a pre-update prompt and a post-update prompt. As illustrated in FIG. 6, on the comparison screen I1, a display field I11 for a pre-update prompt and a display field I12 for a post-update prompt are displayed side by side. The text indicating a pre-update prompt such as “a photo of the sky over the road” is displayed in the display field I11, and the text indicating a post-update prompt such as “a photo of the clouds over the road” is displayed in the display field I12. A superimposed image I13 is displayed in the vicinity of the display field I11. The superimposed image I13 is generated by superimposing the score map output from the VLM on the normal image by applying the pre-update prompt and the normal image to the VLM. A superimposed image I14 is displayed in the vicinity of the display field I12. The superimposed image I14 is generated by superimposing the score map output from the VLM on the normal image by applying the post-update prompt and the normal image to the VLM. Each pixel of the score map is displayed with a color value corresponding to the reaction degree of VLM. Note that a score map may be displayed instead of the superimposed image.

In the superimposed image I13, the entire sky (sky) is highlighted, and it can be seen that the VLM has responded to the character string “sky” described in the pre-update prompt. On the other hand, in the superimposed image I14, the cloud floating in the sky is highlighted, and it can be seen that the VLM has responded to the character string “clouds” described in the post-update prompt. As illustrated in FIG. 6, the pre-update prompt and the post-update prompt are displayed side by side, so that the user can easily grasp a change portion from the pre-update prompt to the post-update prompt. Furthermore, by displaying the superimposed image (or score map) I13 and the superimposed image (or score map) I14 side by side, the user can easily grasp the reaction degree of the VLM to the pre-update prompt and the reaction degree of the VLM to the post-update prompt. Therefore, the user can visually confirm effectiveness of the post-update prompt, and reliability of the prompt included in the prompt list is improved.

### Second Example

The flow of the prompt generation process according to the second example is similar to that in FIG. 3. The prior knowledge according to the second example is second text representing the object of the test image input to the VLM and/or third text representing the aspect whose detection by the VLM is desired.

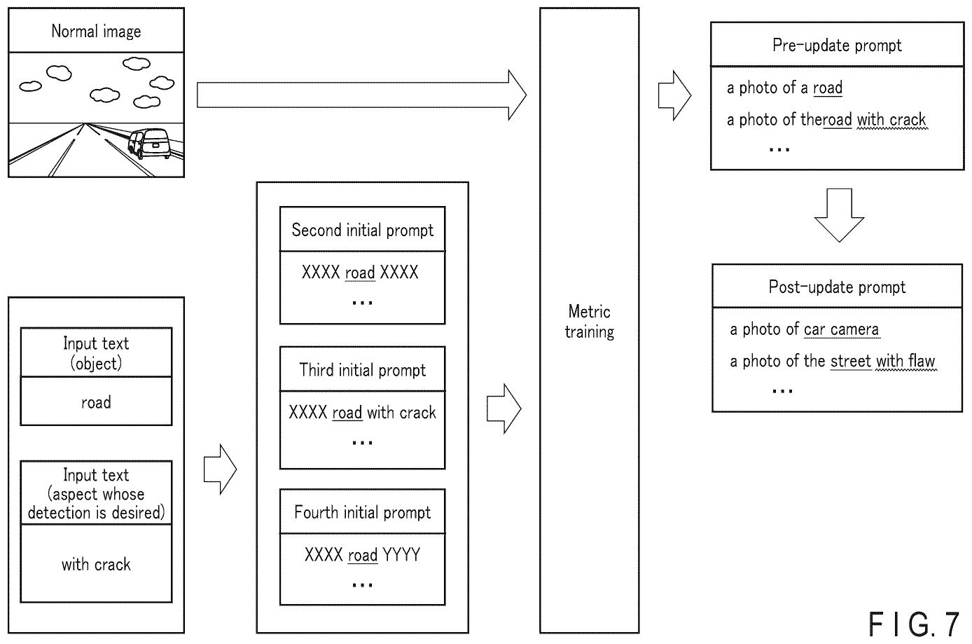

FIG. 7 is a diagram schematically illustrating a transition of various pieces of data according to the second example. Since the flow of processing of the prompt generation circuit 10 according to the first example is the same as that in FIG. 3, the second example will be described with reference to FIGS. 3 and 7. Description of the same processing as that of the first example will be omitted as appropriate.

As illustrated in FIGS. 3 and 7, the training sample acquisition circuit 11 acquires a normal image (step SA1), and the first feature extraction circuit 131 calculates a feature (first feature) of the normal image acquired in step SA1 (step SA2).

In a case where step SA2 is performed, the text input circuit 12 receives the second text representing the object of the test image input to the VLM and the third text representing the aspect whose detection by the VLM is desired (step SA3). For example, as illustrated in FIG. 7, “road” is input as the second text, and “with crack” is input as the third text.

In a case where step SA3 is performed, the prompt initialization circuit 132 generates the first, second and third initial prompts from the second and third text input in step SA3 (step SA4). Specifically, the prompt initialization circuit 132 generates the second initial prompt by converting the second text into a second center token, disposing a predetermined number of second preceding tokens with any values in front of the second center token, and disposing a predetermined number of second subsequent tokens with any values behind the second center token. The prompt initialization circuit 132 generates a third initial prompt by converting the second text into a third center token, disposing a predetermined number of third preceding tokens with any values in front of the third center token, converting the third text into a third subsequent token, and disposing the third subsequent token behind the third center token. The prompt initialization circuit 132 generates a fourth initial prompt by converting the second text into a fourth center token, disposing a predetermined number of fourth preceding tokens with any values in front of the fourth center token, converting another text representing an aspect whose detection by the VLM is desired to a fourth subsequent token, and disposing the fourth subsequent token behind the fourth center token.

For example, as shown in FIG. 7, the second text representing the object is converted into the second center token “road”, the second preceding token “XXXX” is disposed in front of the second center token “road”, the second subsequent token “XXXX” is disposed behind it, and the second initial prompt “XXXX road XXXX” is generated. As shown in FIG. 7, the second text representing the object is converted into the third center token “road”, the third preceding token “XXXX” is disposed in front of the third center token “road”, the third text representing the aspect whose detection is desired is converted into the third subsequent token “with crack”, the third subsequent token “with crack” is disposed behind the third center token “road”, and the third initial prompt “XXXX road with crack” is generated. As shown in FIG. 7, the second text representing the object is converted into the fourth center token “road”, the fourth preceding token “XXXX” is disposed in front of the fourth center token “road”, another text representing the aspect whose detection is desired is converted into the fourth subsequent token “YYYY”, the fourth subsequent token “YYYY” is disposed behind the fourth center token “road”, and the fourth initial prompt “XXXX road YYYY” is generated. Each of “XXXX” and “YYYY” represents four any values. Any different values may be disposed in each of “XXXX” and “YYYY”, or the same value may be disposed. In addition, as described above, the first subsequent token is not essential and may not be disposed.

Hereinafter, an example of the initial prompt generation process will be described in detail. First, the prompt initialization circuit 132 generates L_n (L_n is an integer greater than or equal to 1) second initial prompts pᵢⁿ for the normal object. The second initial prompt pᵢⁿ is mathematically expressed by the following Expression (3). Specifically, second text representing the name of the object is input to the tokenizer to obtain one or more second center tokens T_{obj}. Then the prompt is configured to interpolate tokens before and after the second center token T_{obj}. Here, N second preceding tokens T_{j,k} with any values are disposed in front of T_{obj}, and M second subsequent tokens T_{j,k} with any values are disposed behind T_{obj}. As a result, the second initial prompt pᵢⁿ is generated. N is an integer of 1 or more, M is an integer of 0 or more, and when M=0, no token is disposed after T_{obj}. The token T_{j,k} may be, for example, a token having a value obtained by a random number generator, or may be a token obtained by inputting any character string into a tokenizer. The second initial prompt represents a prompt about the object in a normal case.

$${p}_{1}^{n} = [ {T}_{1 , 1} ] [ {T}_{1 , 2} ] ⋯ [ {T}_{1 , N} ] [ {T}_{obj} ] [ {T}_{1 , N + 1} ] [ {T}_{1 , N + 2} ] ⋯ [ {T}_{1 , N + M} ] , \qquad ( 3 )$$

$${p}_{2}^{n} = [ {T}_{2 , 1} ] [ {T}_{2 , 2} ] ⋯ [ {T}_{2 , N} ] [ {T}_{obj} ] [ {T}_{2 , N + 1} ] [ {T}_{2 , N + 2} ] ⋯ [ {T}_{2 , N + M} ] ,$$

$$⋮$$

$${p}_{{L}_{n}}^{n} = [ {T}_{{L}_{n} , 1} ] [ {T}_{{L}_{n} , 2} ] ⋯ [ {T}_{{L}_{n} , N} ] [ {T}_{obj} ] [ {T}_{{L}_{n} , N + 1} ] [ {T}_{{L}_{n} , N + 2} ] ⋯ [ {T}_{{L}_{n} , N + M} ] .$$

The prompt initialization circuit 132 then generates L_G (L_G is 1 or more) third initial prompts pᵢ^{g} based on the prior knowledge, where the aspect of anomaly is a known prompt. The third initial prompt pᵢ^{g} is mathematically expressed by the following Expression (4). Specifically, one or more third subsequent tokens G_{j,k} constituting L_G character strings related to the aspect of anomaly are disposed behind the third center token T_{obj}. In addition, N third preceding tokens T_{j,k} are disposed before T_{obj}. As a result, the third initial prompt pᵢ^{g} is generated. The third subsequent token G_{j,k} is obtained by inputting L_G character strings related to the aspect of anomaly to the tokenizer. The third initial prompt pᵢ^{g} means a prompt about the object with the anomaly pointed out in the prior knowledge.

$${p}_{1}^{g} = [ {T}_{1 , 1} ] [ {T}_{1 , 2} ] ⋯ [ {T}_{1 , N} ] [ {T}_{obj} ] [ {G}_{1 , N + 1} ] [ {G}_{1 , N + 2} ] ⋯ [ {G}_{1 , N + M} ] , \qquad ( 4 )$$

$${p}_{2}^{g} = [ {T}_{2 , 1} ] [ {T}_{2 , 2} ] ⋯ [ {T}_{2 , N} ] [ {T}_{obj} ] [ {G}_{2 , N + 1} ] [ {G}_{2 , N + 2} ] ⋯… [ {G}_{2 , N + M} ] ,$$

$$⋮$$

$${p}_{{L}_{G}}^{g} = [ {T}_{{L}_{G} , 1} ] [ {T}_{{L}_{G} , 2} ] ⋯ [ {T}_{{L}_{G} , N} ] [ {T}_{obj} ] [ {G}_{{L}_{G} , N + 1} ] [ {G}_{{L}_{G} , N + 2} ] ⋯ [ {G}_{{L}_{G} , N + M} ] .$$

The prompt initialization circuit 132 then generates L_a (L_a is 1 or more) fourth initial prompts pia, where the aspect of anomaly of the object is an unknown prompt. The fourth initial prompt pia is mathematically expressed by the following Expression (5). Specifically, one or more fourth preceding tokens Tik are disposed in front of the fourth center token T_{obj}, and one or more fourth subsequent tokens G_{j,k} are disposed behind the fourth center token T_{obj}. The number of tokens appearing after T_{obj} is matched with the maximum number of tokens appearing after T_{obj} in the L_G prompts based on the foregoing prior knowledge. The fourth subsequent token G_{j,k} is obtained by inputting L_a character strings in which the aspect of anomaly is unknown to the tokenizer. The character string in which the aspect of anomaly is unknown is a character string in which it is not determined whether it is the aspect of anomaly of the object to be detected, and may be manually input by the user via the input device 3, or may be automatically generated by a large language model, a random number generator, or the like. The fourth initial prompt pia means a prompt in which the aspect of anomaly of the object is unknown.

$${p}_{1}^{a} = [ {T}_{1 , 1} ] [ {T}_{1 , 2} ] ⋯ [ {T}_{1 , N} ] [ {T}_{obj} ] [ {G}_{1 , N + 1} ] [ {G}_{1 , N + 2} ] ⋯ [ {G}_{1 , N + M} ] , \qquad ( 5 )$$

$${p}_{2}^{a} = [ {T}_{2 , 1} ] [ {T}_{2 , 2} ] ⋯ [ {T}_{2 , N} ] [ {T}_{obj} ] [ {G}_{2 , N + 1} ] [ {G}_{2 , N + 2} ] ⋯ [ {G}_{2 , N + M} ] ,$$

$$⋮$$

$${p}_{{L}_{a}}^{a} = [ {T}_{{L}_{a} , 1} ] [ {T}_{{L}_{a} , 2} ] ⋯ [ {T}_{{L}_{a} , N} ] [ {T}_{obj} ] [ {G}_{{L}_{a} , N + 1} ] [ {G}_{{L}_{a} , N + 2} ] ⋯ [ {G}_{{L}_{a} , N + M} ] .$$

The foregoing processing generates L_n+L_G+L_a initial prompts.

In a case where step SA4 is performed, the second feature extraction circuit 133 calculates the second feature of the initial prompt generated in step SA4 (step SA5). Specifically, the second feature extraction circuit 133 inputs each of the L_n+L_G+L_a initial prompts to the trained text encoder, and executes forward propagation calculation according to the network structure of the trained text encoder, thereby converting each of the L_n+L_G+L_a initial prompts into a feature vector. The feature vector is an example of the second feature. Here, a feature vector obtained by performing the feature transformation on any of the second, third, and fourth initial prompts p expressed in Expressions (3), (4), and (5) by the text encoder is expressed as w=g (p). w is a prompt in a feature vector format corresponding to the prompt p in a character string format.

In a case where step SA5 is performed, the optimization circuit 134 generates a pre-update prompt by metric training (step SA6). Specifically, the optimization circuit 134 trains the second feature related to the second initial prompt, the second feature related to the third initial prompt, and the second feature related to the fourth initial prompt so that the degree of similarity between the first feature based on the normal image and the second feature related to the second initial prompt increases, and the second feature related to the third initial prompt and the second feature related to the fourth initial prompt approach each other, and generates, as the pre-update prompt, a prompt when satisfying the optimization criterion. The optimization criterion can be set in any criterion.

The mathematical expression of the metric training according to the second example can be expressed by the following Expression (6). That is, in the metric training of the second initial prompt regarding the normal object, the optimization circuit 134 searches for the feature vector win that minimizes the loss value E_{z} based on the feature vector win based on the second initial prompt and the normal image feature z as the local solution. In addition, in the metric training of the fourth initial prompt in which the aspect of anomaly is unknown, the optimization circuit 134 searches for, as a local solution, a feature vector in which the feature vector wₜ^{a} based on the fourth initial prompt is closest to the feature vector wᵤ^{G} based on the third initial prompt in which the aspect of anomaly is known.

$$arg {min}_{{w}_{i}^{n} , {w}_{t}^{a} , {w}_{u}^{G}} \{ {𝔼}_{z} [ - log \frac{exp ( < {w}_{i}^{n} , z / τ > )}{{\sum }_{w ∈ W} exp ( < w , z / τ > )} ] + λ {\sum }_{t , u} {‖ \frac{{w}_{t}^{a}}{{‖ {w}_{t}^{a} ‖}_{2}} - \frac{{w}_{u}^{G}}{{‖ {w}_{u}^{G} ‖}_{2}} ‖}_{2}^{2} \} \qquad ( 6 )$$

In the above Expression (6), z is a normal image feature, W is a set of L_n+L_G+L_a prompts in the feature vector format, and τ and λ are hyperparameters. At the time of this optimization, G_{j,k} in wᵤ^{G} is fixed. In solving Expression (6), for example, each variable is alternately optimized. In the optimization, wᵢⁿ, wₜ^{a}, and wᵤ^{G} in Expression (6) may be replaced with respective representative points. The representative point is obtained by taking an average of the feature vectors.

For example, as shown in FIG. 7, for the second initial prompt having the second center token “road”, the first preceding token “a photo of the” is calculated by the metric training in step SA6, and the pre-update prompt “a photo of the road” is generated. It should be noted that, in this example, for the second subsequent prompt, M=0 is set and the second subsequent prompt is not present. For the third initial prompt with the third center token “road”, the first preceding token “a photo of the” is calculated by the metric training of step SA6 and the pre-update prompt “a photo of the road with crack” is generated.

In a case where step SA6 is performed, the update circuit 14 replaces the input text with the alternative text and generates a post-update prompt (step SA7). Specifically, the update circuit 14 generates the post-update prompts wᵢⁿ′, wₜ^{a}′, and wᵤ^{G}′ by replacing tokens corresponding to the second text and the third text in the prompts wᵢⁿ, wₜ^{a}, and wᵤ^{G} in the feature vector format with tokens corresponding to the alternative text. As a method of acquiring the alternative text, the first method or the second method can be used as in the first example. A post-update prompt is generated for each of the L_n+L_G+L_a pre-update prompts.

For example, as shown in FIG. 7, for the pre-update prompt “a photo of a road”, “road” is replaced with the alternative text “car camera”, and the post-update prompt “a photo of a car camera” is generated. Further, for the pre-update prompt “a photo of the road with crack”, “road” is replaced with the alternative text “street”, and “with crack” is replaced with the alternative text “with flaw”, and the post-update prompt “a photo of the street with flaw” is generated.

In a case where step SA7 is performed, the evaluation circuit 15 evaluates the effectiveness of the post-update prompt generated in step SA7 (step SA8). The evaluation method according to the second example is the same as the evaluation method according to the first example. For example, the evaluation circuit 15 evaluates the effectiveness of the post-update prompt based on a comparison between the score map S representing the detection result of the anomaly by the post-update prompt and the score map S′ representing the detection result of the anomaly by the pre-update prompt. Here, the score map S and the score map S′ based on the same type of initial prompt among the second, third, and fourth initial prompts may be compared, or the score map S and the score map S′ based on different types of initial prompts may be compared. As an example of comparing the score map S with the score map S′ based on different types of initial prompts, the evaluation circuit 15 may compare the score map S obtained by applying the normal image and the pre-update prompt based on the second initial prompt to the trained VLM with the score map S′ obtained by applying the normal image and the post-update prompt based on the fourth initial prompt to the trained VLM. In this case, the evaluation unit may evaluate that the post-update prompt is effective in a case where the statistical value of the entire score map S′ or the high response region of the score map S′ is smaller than the threshold value, compared with the statistical value of the entire score map S′ or the high response region.

In a case where step SA7 is performed, the output circuit 16 outputs a prompt (step SA8). Specifically, in a case where there is a post-update prompt evaluated to be effective in step SA8, the output circuit 16 adds the post-update prompt to the prompt list. At this time, the output circuit 16 may add the pre-update prompt to the prompt list in addition to the post-update prompt. On the other hand, in a case where there is no post-update prompt evaluated to be effective in step SA8, the output circuit 16 discards the post-update prompt and adds the pre-update prompt to the prompt list. After completion of addition and/or discard of the L_n+L_G+L_a post-update prompts, the output circuit 16 outputs the prompt list.

As described above, the prompt generation process according to the second example ends. As in the first example, in the second example, various types of processing can be added, deleted, and/or changed without departing from the gist of the invention. Only one of the second text and the third text may be input as the input text.

As in the above embodiment, the anomaly detection apparatus 100 according to the present embodiment includes the metric training circuit 13 and the update circuit 14. The metric training circuit 13 generates one or more pre-update prompts for input to the VLM from the training sample and the input text representing the aspect of the training sample by metric training based on a comparison between the sample and the prompt. For each of the generated pre-update prompts, the update circuit 14 searches for alternative text as an alternative to the input text included in the prompt and generates the post-update prompt by replacing the input text with the alternative text.

In metric training in which a plurality of prompts is generated based on the input text representing an aspect of a training sample, good or bad of the input text leads to accuracy of the prompt, and eventually, accuracy of anomaly detection by the VLM using the prompt. As the incompleteness of the text, an error in the text, a lack of the text, a difference between the intention of the user and the recognition of the VLM, and the like are assumed. According to the above configuration, even in a case where the input text regarding the prior knowledge input by the user is incomplete, it is possible to automatically obtain the post-update prompt in which the input text is corrected to the alternative text, from the pre-update prompt including the input text. This makes it possible to generate a relatively effective prompt even in a case where the accuracy of the input text is not good. In addition, by using both the metric training and the prompt update, the user gives the minimum prior knowledge as the input text, and thus, even in a case where the prior knowledge given by the user is inappropriate and/or insufficient, it is possible to correct and/or complement the prior knowledge. Therefore, it is possible to reduce the user's labor related to the idea and input of the text. Since the alternative text depends on the input text, the post-change prompt does not significantly change from the pre-update prompt, which also contributes to predictability. In addition, by evaluating effectiveness of the post-update prompt, it is possible to perform anomaly detection by using only a prompt with high effectiveness, and improvement in accuracy of anomaly detection can be expected.

In the first example, the first text (the text about the prior knowledge about the normal aspect that the user does not want to overdetect) representing the aspect whose detection by the VLM is not desired is input, and the prompt is generated accordingly, so that the overdetection in the anomaly detection can be reduced according to the intention of the user. The accuracy of anomaly detection can be expected to be improved by reducing overdetection. In the second example, the second text representing the object of the test sample input to the VLM and/or the third text representing the aspect whose detection by the VLM is desired are input, and a prompt corresponding thereto is generated, so that the aspect whose detection the user desires can be appropriately detected.

### (Anomaly Detection Process)

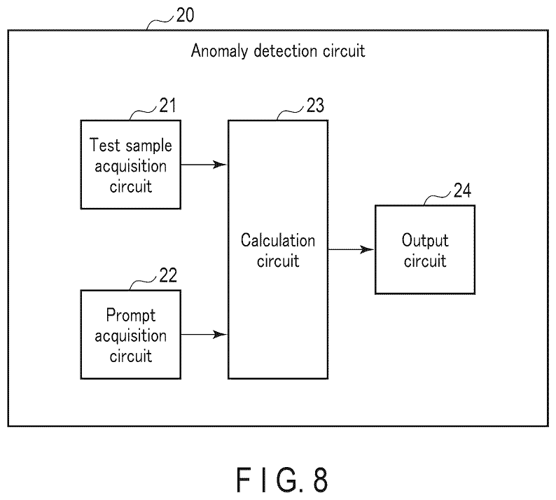

FIG. 8 is a diagram illustrating an example of a configuration of the anomaly detection circuit 20 illustrated in FIG. 1. As illustrated in FIG. 8, the anomaly detection circuit 20 includes a test sample acquisition circuit 21, a prompt acquisition circuit 22, a calculation circuit 23, and an output circuit 24.

The test sample acquisition circuit 21 acquires a test sample. It is desirable that the test training sample belongs to the same domain as the training sample. The prompt acquisition circuit 22 acquires the prompt list output by the prompt generation circuit 10. The prompt list includes a pre-update prompt and/or a post-update prompt evaluated to be effective. The calculation circuit 23 calculates the anomaly detection result related to the test sample by applying, to the VLM, the test sample acquired by the test sample acquisition circuit 21, the pre-update prompt included in the prompt list acquired by the prompt acquisition circuit 22 and/or the post-update prompt evaluated to be effective as an input to the VLM. The output circuit 24 outputs an anomaly detection result.

Next, the anomaly detection process of the test sample will be described. In the following description, it is assumed that the data format of the sample is an image.

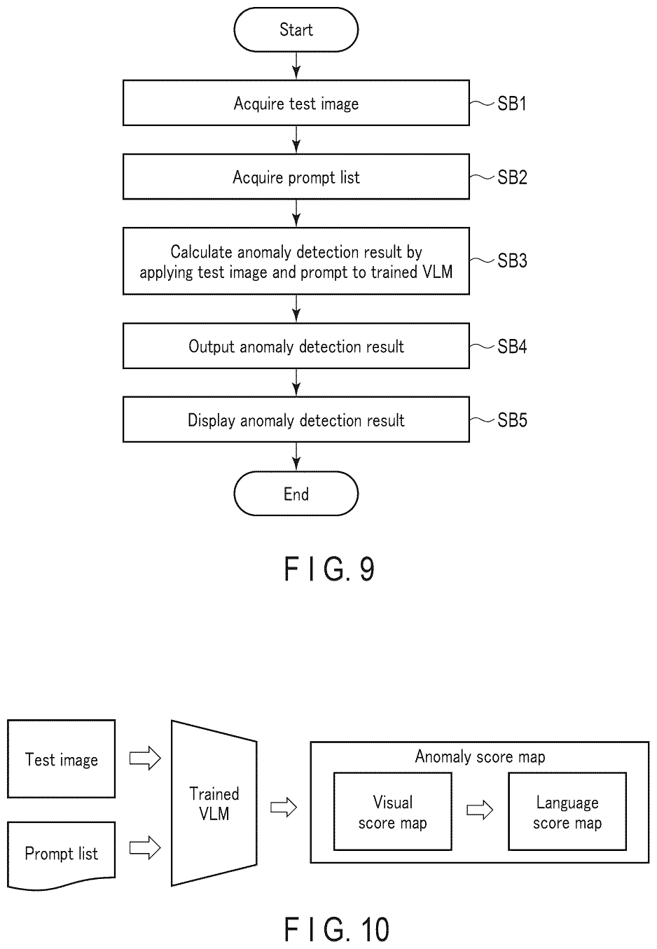

FIG. 9 is a diagram illustrating a processing example of anomaly detection according to the present embodiment. As illustrated in FIG. 9, the test sample acquisition circuit 21 acquires a test image (step SB1). The test image may be stored in the storage apparatus 2, may be input by a user or the like via the input device 3, or may be transferred from another computer via the communication device 5.

In a case where step SB1 is performed, the prompt acquisition circuit 22 acquires the prompt list output by the prompt generation circuit 10 (step SB2). As described above, the prompt list includes a pre-update prompt and/or a post-update prompt that is evaluated to be effective. The prompt list may be stored in the storage apparatus 2, may be input by a user or the like via the input device 3, or may be transferred from another computer via the communication device 5.

In a case where step SB2 is performed, the calculation circuit 23 applies the test image acquired in step SB1 and the prompt list acquired in step SB2 to the trained VLM to calculate an anomaly detection result (step SB3). The calculation circuit 23 calculates, as the anomaly detection result, an anomaly score representing the degree of anomaly of the test image, an anomaly score map representing the spatial distribution of the anomaly score, and/or a statistical value of the anomaly score in the anomaly score map. The anomaly score is designed so that the higher the value, the higher the probability that the test image has an anomaly.

FIG. 10 is a diagram schematically illustrating input and output of the trained VLM. As illustrated in FIG. 10, the trained VLM receives the test image and the prompt list to output an anomaly score map. At this time, a plurality of prompts included in the prompt list, that is, L pre-update or post-update prompts in the case of the first example, and L_n+L_G+L_a pre-update or post-update prompts in the case of the second example are collectively input to the trained VLM. In a case where the prompt is in a text format, the calculation circuit 23 applies the prompt to a text encoder to convert it into a feature vector format, and inputs the prompt in the feature vector format to the trained VLM.

The calculation circuit 23 calculates an anomaly score map using the trained VLM according to the following procedure. Hereinafter, it is assumed that the VLM is a neural network model (hereinafter, referred to as a visual neural network model) used in Contrastive Language Image Pretraining (CLIP). First, the calculation circuit 23 inputs the test image to the trained visual neural network model and calculates a visual score map and a visual feature vector. As the trained visual neural network model, any neural network, such as a ViT, a Convolutional Neural Network (CNN), or the like, can be used.

As an example, in the case of using the ViT, the calculation circuit 23 calculates the visual score map by integrating the outputs from the respective intermediate layers included in the ViT by combining, averaging, or the like. At this time, the calculation circuit 23 may generate the visual score map by applying filter processing using an attention mechanism to the output from each intermediate layer as in Non-Patent Literature 2.

As another example, in a case where the CNN is used, the calculation circuit 23 may generate the visual score map by scaling the outputs from the respective intermediate layers included in the CNN so that the sizes thereof coincide with each other and then integrating the outputs by combining, averaging, or the like. Any interpolation method can be used in the scaling.

The calculation circuit 23 acquires an output from the output layer of the trained visual neural network as a visual feature vector.

Next, for each pixel of the visual score map, the calculation circuit 23 calculates the degree of similarity between the feature vector in the channel direction and the prompt in the feature vector format in each pixel. This is defined as a language score map. The calculation of the language score map can be formulated as, for example, the following Expression (7).

$${S}_{L} ( x , y ) = \frac{exp ( < Z ( x , y ) , {w}^{a} / τ > )}{exp ( < Z ( x , y ) , {w}^{n} / τ > ) + exp ( < Z ( x , y ) , {w}^{a} / τ > )} \qquad ( 7 )$$

In Expression (7), w^{a} is a prompt about an anomaly aspect, and w″ is a prompt about a normal aspect. w^{a} may be calculated by, for example, the method of Non-Patent Literature 2. Alternatively, the calculation may be performed by inputting one or more text sentences describing an anomaly aspect in the image to the text encoder. wⁿ can also be calculated based on a similar method. However, wⁿ may be obtained by integrating or replacing the prompt estimated using the present embodiment. Z (x, y) is a feature vector in a channel direction at coordinates (x, y) of the visual score map, and S_{L} (x, y) is a value at coordinates (x, y) of the language score map.

The anomaly score map based on the trained VLM is obtained by outputting one of the visual score map and the language score map or by outputting both of them in an integrated manner. Usually, in a case where both the visual score map and the language score map are integrated, any of an average, a harmonic average, a weighted average, a sum, and a weighted sum is used.

The anomaly score of the image based on the trained VLM may be calculated in the same procedure as the anomaly score map using the degree of similarity between the visual feature vector and the prompt in the feature vector format. The anomaly score of the image may be calculated from the anomaly score map. In this case, for example, an average value, a maximum value, an average value of portions equal to or more than a threshold value, an average value in a specific region, and the like of the anomaly score map are calculated as anomaly scores.

In a case where step SB3 is performed, the output circuit 24 outputs the anomaly detection result calculated in step SB3. The output circuit 24 selects to output, as an anomaly detection result, any one or more of an anomaly score of the test image, an anomaly score map, and an anomaly score map subjected to threshold value processing. The anomaly detection result is stored in the storage apparatus 2 in any file format.

In a case where step SB4 is performed, the display control circuit 30 displays the anomaly detection result output in step SB4 on the display device 4 (step SB5). For example, the display control circuit 30 displays the anomaly score map generated in step SB2 on the display device 4. At this time, the display control circuit 30 may display the anomaly score map as a heat map with a color value corresponding to the degree of anomaly. For example, the color value may be set so that the color is blue as the degree of anomaly decreases, and is red as the degree of anomaly increases. In addition, the display control circuit 30 may display the anomaly score map on the test image in a superimposed manner. As a result, the user can check the degree of anomaly in each pixel of the test image. In addition, the display control circuit 30 may illustrate and visualize the portion where the anomaly score is equal to or higher than the threshold value in any shape by surrounding the portion with a rectangle or by another method. Note that the display control circuit 30 may display either one or both of the visual score map and the language score map as the anomaly score map.

Thus, the anomaly detection process illustrated in FIG. 9 ends.

As described above, the anomaly detection circuit 20 according to the present embodiment can detect an anomaly of the test sample by inputting a post-update prompt in which the input text is replaced with the alternative text to the VLM. As described above, since the post-update prompt has relatively high effectiveness of an input to the VLM and can be generated relatively easily, as a result, it is expected to easily improve the accuracy of anomaly detection.

Thus, according to the present embodiment, it is possible to provide an anomaly detection apparatus, a method, and a program capable of generating an appropriate prompt as a prompt to be input to the VLM that is an example of a multi-modal base model.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An anomaly detection apparatus comprising:
a metric training circuit that generates one or more pre-update prompts for input to a multi-modal base model from a training sample and input text representing an aspect of the training sample by metric training based on a comparison between a sample and a prompt; and
an update circuit that, for each of the generated pre-update prompts, generates a post-update prompt by searching for alternative text as an alternative to the input text included in the prompt, and replacing the input text with the alternative text.

2. The anomaly detection apparatus according to claim 1, wherein
the metric training circuit includes
a first extraction circuit that extracts a first feature from the training sample,
an initialization circuit that generates one or more initial prompts from the input text,
a second extraction circuit that extracts a second feature from each of the initial prompts, and
an optimization circuit that generates the pre-update prompt in which a degree of similarity between the first feature and the second feature satisfies a predetermined criterion.

3. The anomaly detection apparatus according to claim 2, further comprising
an input circuit that receives, as the input text, a first text representing an aspect whose detection by the multi-modal base model is not desired, wherein
the initialization circuit generates a first initial prompt by converting the first text into a first center token, disposing a predetermined number of first preceding tokens with any values in front of the first center token, and/or disposing a predetermined number of first subsequent tokens with any values behind the first center token.

4. The anomaly detection apparatus according to claim 3, wherein
the optimization circuit trains the second feature related to the first initial prompt so that the degree of similarity increases, and generates, as the pre-update prompt, a prompt in a case where the predetermined criterion is satisfied.

5. The anomaly detection apparatus according to claim 2, further comprising
an input circuit that receives, as the input text, second text representing an object of a test sample input to the multi-modal base model and/or third text representing an aspect whose detection by the multi-modal base model is desired, wherein
the initialization circuit
generates a second initial prompt by converting the second text into a second center token, disposing a predetermined number of second preceding tokens with any values in front of the second center token, and disposing a predetermined number of second subsequent tokens with any values behind the second center token,
generates a third initial prompt by converting the second text into a third center token, disposing a predetermined number of third preceding tokens with any values in front of the third center token, converting the third text into a third subsequent token, and disposing the third subsequent token behind the third center token, and
generates a fourth initial prompt by converting the second text into a fourth center token, disposing a predetermined number of fourth preceding tokens with any values in front of the fourth center token, converting another text representing an aspect whose detection by the multi-modal base model is desired into a fourth subsequent token, and disposing the fourth subsequent token behind the fourth center token.

6. The anomaly detection apparatus according to claim 5, wherein
the optimization circuit trains the second feature related to the second initial prompt, the second feature related to the third initial prompt, and the second feature to be transferred to the fourth initial prompt so that a degree of similarity between the first feature and the second feature related to the second initial prompt is increased, and the second feature related to the third initial prompt and the second feature related to the fourth initial prompt approach each other, and generates, as the pre-update prompt, a prompt in a case where the predetermined criterion is satisfied.

7. The anomaly detection apparatus according to claim 1, wherein the update circuit inquires of a large language model about text as an alternative to the input text, and acquires text output from the large language model as the alternative text.

8. The anomaly detection apparatus according to claim 1, wherein the update circuit acquires, as the alternative text, text corresponding to a token similar in a feature space to a token of the input text.

9. The anomaly detection apparatus according to claim 1, further comprising an evaluation circuit that evaluates the effectiveness of the post-update prompt as an input to the multi-modal base model based on a detection result of an anomaly by the post-update prompt or a comparison between the detection result of the anomaly by the post-update prompt and a detection result of an anomaly by the pre-update prompt.

10. The anomaly detection apparatus according to claim 9, further comprising an output circuit that adds the post-update prompt to a list of prompts to be used for input to the multi-modal base model in a case where there is the post-update prompt that is evaluated to be effective as an input to the multi-modal base model, and discards the post-update prompt and adds the pre-update prompt to the list in a case where there is no post-update prompt that is evaluated as effective as an input to the multi-modal base model.

11. The anomaly detection apparatus according to claim 2, further comprising a detection circuit that outputs an anomaly detection result regarding the test sample by applying a test sample, the pre-update prompt, and/or the post-update prompt evaluated to be effective as an input to the multi-modal base model to the multi-modal base model.

12. The anomaly detection apparatus according to claim 11, wherein the detection circuit calculates, as the anomaly detection result, an anomaly score indicating a degree of anomaly of the test sample, an anomaly score map indicating a spatial distribution of the anomaly score, and/or a statistical value of the anomaly score in the anomaly score map.

13. The anomaly detection apparatus according to claim 1, further comprising a display control circuit that displays the pre-update prompt and the post-update prompt side by side on a display device.

14. The anomaly detection apparatus according to claim 13, wherein the display control circuit further displays a score map based on the pre-update prompt and the training sample and a score map based on the post-update prompt and the training sample side by side.

15. The anomaly detection apparatus according to claim 1, wherein the training sample is an image, a video, a sound, or coordinates.

16. The anomaly detection apparatus according to claim 1, wherein
the training sample is an image,
the multi-modal base model is a visual language base model that receives an image and a prompt, and detects an anomaly included in the image and associated with the prompt, and
the training sample is a normal image including no anomaly.

17. A computer-implemented anomaly detection method comprising:
generating one or more pre-update prompts for input to a multi-modal base model from a training sample and input text representing an aspect of the training sample by metric training based on a comparison between a sample and a prompt; and
for each of the generated pre-update prompts, generating a post-update prompt by searching for alternative text as an alternative to the input text included in the prompt, and replacing the input text with the alternative text.

18. A non-transitory computer readable medium including computer executable instructions, wherein the instructions, when executed by a processor, cause the processor to perform operations comprising:
generating one or more pre-update prompts for input to a multi-modal base model from a training sample and input text representing an aspect of the training sample by metric training based on a comparison between a sample and a prompt; and
for each of the generated pre-update prompts, generating a post-update prompt by searching for alternative text as an alternative to the input text included in the prompt, and replacing the input text with the alternative text.
